(19) United States
(12) Patent Application Publication
(10) Pub. No.: US 2005/0216349 A1
(43) Pub. Date: Sep. 29, 2005

(54) Portable timer system for restaurant inventory management

(75) Inventors: Dennis J. Vaseloff, Gurnee, IL (US); Loren J. Veltrop, Deerfield, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: PRINCE CASTLE, INC.

(21) Appl. No.: 10/809,763

(22) Filed: Mar. 25, 2004

(51) Int. Cl. G06F 17/60

(52) U.S. Cl. 705/15

(57) ABSTRACT

A portable timer system and method for restaurant inventory management includes a plurality of portable timers that connect to one or more food preparation, processing, and/or storage devices typically used in restaurants. The portable timer system may include at least one timer programming station, a computing device, and a handheld computing device. Each portable timer can updated include updated information about the food products being operated on in the food devices, and such information can be transferred with the portable timer as the food product is transferred from one food device to another. A restaurant can utilize the portable timer system and method to manage the food inventory therein by having current information about food products that are being processed, prepared, and stored in the restaurant.

### FIELD OF THE DISCLOSURE

The present disclosure generally relates to food inventory management in a restaurant, and more particularly, to a portable timer system and method for restaurant inventory management.

### BACKGROUND

Success of a fast food restaurant depends on whether the restaurant operator can efficiently manage the food inventory and the processing thereof. Ideally, at any moment during the operation of a restaurant, the inventory levels of all food products in the restaurant at various stages of production (e.g., unprocessed, processed, uncooked, and cooked) should be known for efficient management of the food inventory. In most restaurants, however, the food inventory is typically checked or updated periodically. Excessive inventory checks can be labor intensive and costly. In contrast, too few inventory checks may disrupt the preparation and service of food to customers, because the updated inventory levels may not reflect the actual amounts of food products available to be served.

Particularly applicable to fast food restaurants is the criterion that a customer should be served with a food product as soon as his order is taken. Ideally, if the rate at which a restaurant cooks a food product and the rate at which the food product is sold are equal, the restaurant will have fresh food product on hand and ready to serve. In other words, for the ideal fast food restaurant operation, the operator must know how many food products will be sold in the future. Although historical sales data for a food product can be used to predict future rates of sale, the prediction is highly approximate and subject to numerous unpredictable events and variables that the historical data do not reflect. As a result, a restaurant operator must precook a certain number of food products and have the cooked products on hand for immediate service.

Therefore, it would be beneficial to have a system for managing the food inventory of a restaurant during various stages of food production, which may include storage of uncooked food product, preparation and processing of uncooked food product, cooking of the food product, storing the cooked food product, relocating the cooked food product to various locations in the restaurant, and serving the cooked food product to customers.

### BRIEF DESCRIPTION OF THE DRAWINGS

FIG. 1 is a schematic diagram of a first exemplary portable timer system constructed in accordance with the teachings of the present disclosure.

FIG. 2 is a schematic diagram of a second exemplary portable timer system constructed in accordance with the teachings of the present disclosure.

FIG. 3 is a perspective view of an exemplary portable timer of a portable timer system constructed in accordance with the teachings of the present disclosure.

FIG. 4 is a schematic block diagram of an exemplary portable timer of a portable timer system constructed in accordance with the teachings of the present disclosure.

FIG. 5 is a perspective view of an exemplary food device for use with a portable timer system constructed in accordance with the teachings of the present disclosure.

### DETAILED DESCRIPTION

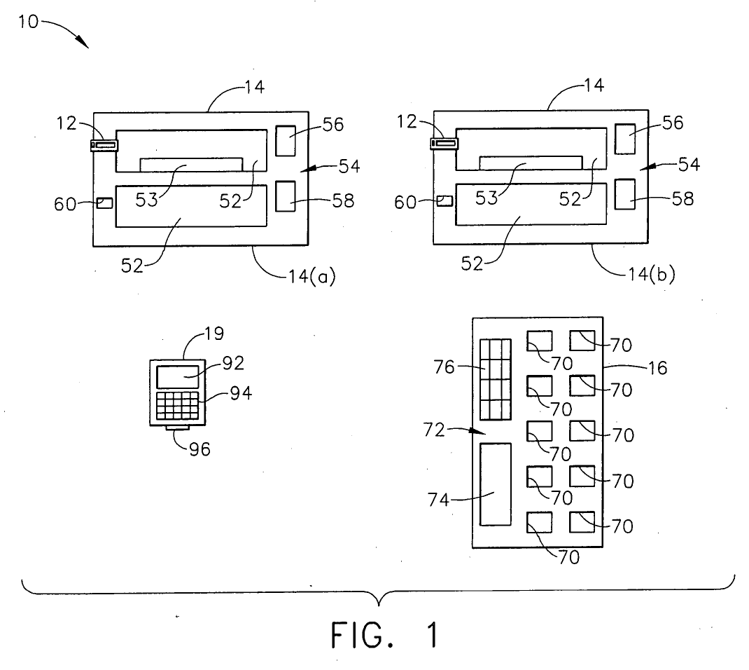

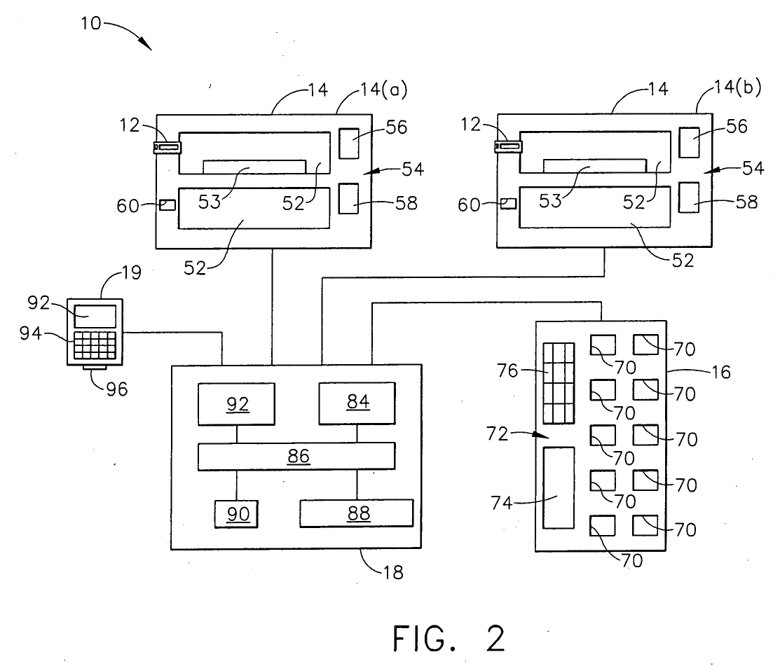

Referring to FIGS. 1 and 2, a portable timer system 10 in accordance with the teachings of the present disclosure is generally shown. The portable timer system 10 includes a plurality of portable timers 12 that connect to one or more food preparation, processing, and/or storage devices, which will be referred to in the following as food devices 14. The portable timer system 10 may include at least one timer programming station 16 that can program each of the portable timers 12. Additionally, the portable timer system 10 may include a computing device 18 for managing the operation of the portable timer system 10 and to facilitate communication between the components of the portable timer system 10. The portable timer system 10 may also include one or more mobile or handheld computing and communication devices 19, which will be referred to in the following as the handheld device 19. Each portable timer 12 can include updated information about the food products being operated on in the food device 14, and such information can be transferred with each portable timer 12 as the corresponding food product is transferred from one food device 14 to another. Accordingly, a restaurant can utilize the disclosed portable timer system 10 and method to manage the food inventory therein by having current information about food products that are being processed, prepared, and stored in the restaurant. In a first example of the disclosed portable timer system 10 as shown in FIG. 1, the portable timers 12 are not connected and do not communicate directly with each other. In a second example of the disclosed portable timer system 10 as shown in FIG. 2, the portable timers 12 and/or the food devices 14 to which they are connected, communicate with each other.

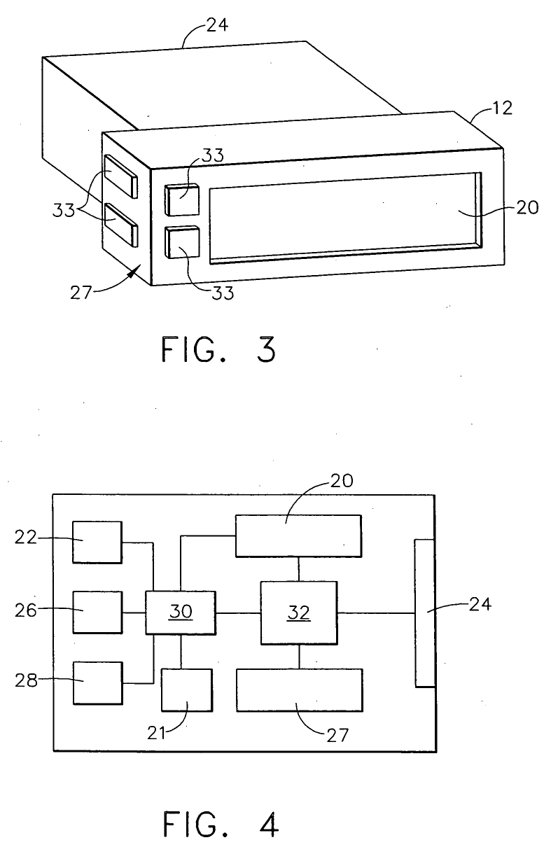

Referring to FIGS. 3 and 4, the portable timer 12 can include a display device 20, an internal clock 21, and a communication port 24. Accordingly, the portable timer 12 can at least provide timing information for the food product in a food device 14 to which it is connected. However, the portable timer 12 may also include an internal memory 22, a processor 26, a control panel 27, and an internal power supply 28. The display device 20 can simply include one or more LED's (light emitting diodes). The display device 20 can also display alphanumeric information, such as numbers, letters, or a combination thereof. The display 20 may also display information graphically. The memory 22 of each portable timer 12 can store information about food products in the food device 14 to which the portable timer 12 is connected. The information stored in the memory 22 can include at least the type of food product in the food device 14 to which the portable timer 12 is connected, and the time elapsed since the food product has been operated on by the food device 14.

The memory 22 can also include operation software for the portable timer 12. The software can be executed in the processor 26, which also manages the operation of the portable timer 12. The display device 20, the memory 22, and the processor 26 can communicate with each other through a communication bus 30. Additionally, the communication bus 30 can also be in communication with the communication port 24 through an input/output controller 32. The operational software may include a software driven timer for the timer function of the portable timer 12 and various software modules for managing the operations of the portable timer 12.

The communication port 24 may be any one of the standard data exchange communication ports that can be found on electronic and computing devices. Such standard communication ports include Universal Serial Bus (USB) ports, Firewire ports based on the IEEE 1394 standard, serial ports, parallel ports, or other wired or wireless communication ports. The communication port 24 may also be a non-standard port that is capable of exchanging information with devices that include compatible receiving ports. The portable timer 12 may be internally powered, in which case each portable timer 12 can also include a portable and internal power supply, such as a battery (not shown). In such portable timer 12, the display 20 can provide a battery power indicator (not shown) that can alert a user about remaining battery life. Each portable timer 12 may also be powered by a device to which it connects through the communication port 24. For example, a portable timer 12 that uses a USB port as the communication port 24 can receive power from a device to which it connects through the USB port. If the portable timer 12 is not self powered, the memory 22 can include non-volatile memory so that information can be retained in the portable timer 12 when the portable timer 12 is not connected to a power source.

The control panel 27 of each portable timer 12 may include any number of buttons, knobs, switches or other user operated control mechanisms. In the exemplary portable timer 12 of FIG. 3, the control panel 27 is shown as having four buttons 33 to illustrate the operation of the portable timer system 10. The control panel 27 can provide a user with the ability to define, control, and/or change various simple to complex operational parameters and characteristics of the portable timer 12. Each of the four buttons 33, or select groups of the four buttons 33, can change certain operational functions of the portable timer 12. For example, pressing one of the buttons 33 can simply reset the time on the portable timer 12. A select group of the buttons 33, for example, can activate a setup menu that is displayed on the display device 20, so as to allow an operator to visually set the desired operational parameters of the portable timer 12. In yet another example, pressing one or more of the control buttons 33 can store the necessary information on the memory 22 before a user can disengage a portable timer 12 from the food device 14 to which the timer is connected. Based on the above-described exemplary functions of the control panel 27, one of ordinary skill in the art will appreciate the numerous possible methods by which the control panel 27 can define, control, update, and/or change the various operational characteristics of the portable timer 12.

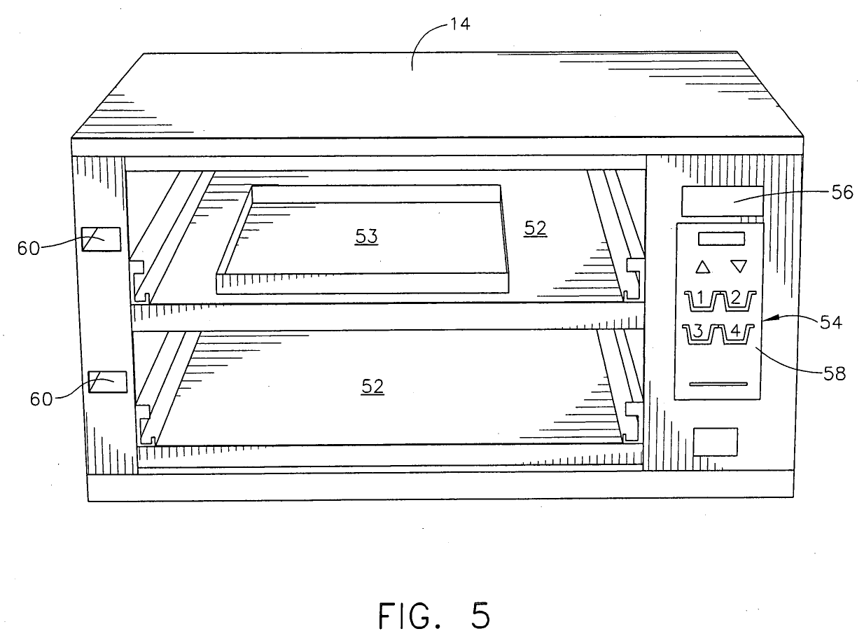

Referring to FIG. 5, a food device 14 is generally shown. The food device 14 generally illustrates the various types of food preparation, processing, and storage devices that may be found in a typical restaurant. For example, the food device 14 may be a food refrigeration device, a food processor, a mixer, a fryer, a grill, a food warming cabinet, or any other food preparation, processing, and storage device that can be found in a restaurant environment. Of the noted food devices 14, a food warming cabinet 14 is described in the following discussion to illustrate the operation of the disclosed portable timer system 10 and method for restaurant inventory management. Additionally, the food devices 14 will be interchangeably referred to in the following as warming cabinets 14 where making such a reference is applicable. However, the disclosed portable timer system 10 and method for restaurant inventory management is equally applicable to food devices other than the exemplary warming cabinet 14.

The warming cabinets 14 can cook and/or maintain freshly prepared food products at a temperature specific to the food products. By keeping a prepared food product at a specific temperature, the food product can remain in a serviceable condition, i.e., fresh, for a period of time, which may also be specific to that particular type of food products. Accordingly, a restaurant operator does not have to cook a food product every time an order for the food product is received. The operator can cook a batch of the food product and store it in the warming cabinets 14. When an order is received, it can be immediately filled by using the warm food product stored in the warming cabinets 14. An operator can then keep track of the quantities of warm food product remaining or the time the food product has been stored in the warming cabinets 14, and cook additional quantities of the food product prior to depleting the warm supply of the food product.

Each food device including the warming cabinet 14 includes one or more slots 52 for receiving food trays 53, and may include a user interface 54. The food trays 53 are containers that hold the food products, regardless of the type of food products being contained therein. Accordingly, although the word “tray” as used herein may infer a shape for the food trays 53, one of ordinary skill in the art will appreciate that the food trays 53 may be any shape, size, or configuration to accommodate any type of food products. The user interface 54 may include an output device such as a display panel 56 for displaying various operational parameters of the food device 14, and may also include a control panel 58.

Each food device including the warming cabinet 14 includes at least one communication slot 60 for receiving a portable timer 12. However, because each slot 52 may contain food products that may be different from the food products in adjacent slots 52, as shown in FIG. 5, each of the slots 52 of the food device 14 includes a communication slot 60. Each communication slot 60 is adapted to receive a communication port 24 of a portable timer 12. Accordingly, the communication slot 60 is of the same type of port as, or compatible with, the communication port 24. For example, if the communication port 24 is a male USB port, then the communication slot 60 is a female USB port. The communication slots 60 may be an integral part of the food device 14, as shown in FIG. 5. Alternately, stand-alone communication slots 60 (not shown) can be attached to a food device 14, thereby modifying an existing food device 14 for use with the disclosed portable timer system 10.

When a portable timer 12 is inserted in a communication slot 60 of a food device 14, communication or information exchange between the food device 14 and the portable timer 12 may be automatically initiated. Alternately, a user can activate the communication by either pressing one or more buttons 33 of the control panel 27 of the portable timer 12, or a button (not shown) on the control panel 58 of the food device 14. Additionally, if the portable timer 12 includes an internal battery, the battery will be recharged by the food device 14 through the communication slot 60 when the portable timer 12 is inserted in the communication slot 60.

Referring to FIGS. 1 and 2, a timer programming station 16 is generally shown. The timer programming station 16 includes a plurality of timer slots 70, and a user interface 72 that may include a display device 74 and a control panel 76. Each of the timer slots 70 can receive a portable timer 12, and therefore, each timer slot 70 is similar to the communication ports 60 of each food device 14. When a portable timer 12 is inserted in one of the timer slots 70, communication or information exchange between the timer programming station 16 and the portable timer 12 may be automatically initiated. Alternately, a user can activate the communication by pressing a button on the control panel 76 of the timer programming station 16.

The timer programming station 16 can provide any one or a combination of the following functions: programming each portable timer 12 to perform a desired operation, resetting the portable timer 12 after performing an operation, updating each portable timer 12 based on operational changes encountered by the portable timer 12, and reading information from and writing information to the memory of the portable timer 12. If the portable timer 12 includes an internal software for managing the operations thereof, the timer programming station 16 can also reset, update, modify, or completely rewrite the software that is stored in the memory of the portable timer 12. The timer programming station 16 may also serve as a battery recharging station for the portable timers 12 if each portable timer 12 has an internal battery. Accordingly, the internal battery of any portable timer 12 that is inserted in any of the timer slots 70 can be recharged by the programming station 16 through the timer slot 70.

The timer programming station 16 can also serve as a holding station for portable timers 12 that are not currently being used, extra or backup portable timers 12, and/or portable timers 12 that are in the process of being programmed. Accordingly, when a portable timer is needed for insertion in a communication slot 60 of a food device 14, a user can pull a portable timer 12 out of one of the timer slots 70 for use. However, as will be described below, the user may have to program the portable timer 12 for the particular operation desired prior to removing the portable timer from the programming station 16.

Referring back to FIG. 2, the computing device 18 manages various resources of the portable timer system 10. Such managing of the resources may include managing the operation of the components of the portable timer system 10, and facilitating communication among the food devices 14, portable timers 12, and the timer programming station 16. As used herein, “computing device” refers to any computing system (e.g., portable computer, laptop computer, PDA, desktop computer, server, etc.) that employs a processor 82 for executing a series of instructions that are stored in a machine-accessible medium. The computing device 18 may contain one or more conventional hardware components of a typical computer system that is well known to those of ordinary skill in the art. Such components include a data storage device 84, a communications bus 86, a power supply 88, the processor 82, a memory 90, and an input-output controller 92.

Referring to FIGS. 1 and 2, portable timer system 10 can also include one or more of the handheld devices 19. The handheld device 19 can manage various resources of the portable timer system 10. Such managing of the resources may include managing the operation of the components of the portable timer system 10, and facilitating communication among the food devices 14, portable timers 12, and the timer programming station 16. As used herein, “handheld device” refers to any portable or mobile computing and/or communication system (e.g., laptop computer, personal digital assistant, or the like) that employs a processor for executing a series of instructions that are stored in a machine-accessible medium. The handheld device 19 includes a display device 92 and a control panel 94. The handheld device 19 may also include a communication port 96 for receiving a portable timer 12. The handheld device 19 may further include one or more conventional hardware components of a typical handheld computer system that are well known to those of ordinary skill in the art. Such components include a data storage device, a communications bus, a power supply, a processor, a memory, a display device, a communication device that may be capable of wired or wireless communication, and an input-output controller. As will be described in the following, the handheld device 19 may communicate with the computing device 18, function as an extension of the computing device 18, or operate independently of the computing device 18. Alternately, a portable timer system 10 may only include one or more handheld devices 19 and may not include a computing device 18.

Even though the computing device 18 is shown in FIG. 2 as a stand-alone device having the components described above, the components can be external to the computing device 80 and be housed in the food devices 14 or the timer programming device 16. Furthermore, the entire computing device 18 can be incorporated in the timer programming station 16 or one of the food devices 14 and integrally function therewith. Additionally, although the computing device 18 is disclosed as the only such device in the portable timer system 10, a plurality of computing devices 18 can be provided that operate independently or jointly by communicating with each other. For example, a plurality of the handheld devices 19 can be provided. Each handheld device 19 can provide the functions of the computing device 18 and communicate with the other handheld devices. In the portable timer system 10 that is illustrated in FIG. 2, a centralized computing device 18 is shown. However, as described in the foregoing, a variety of computing devices 18 and computing device configurations can be used in the disclosed portable timer system 10 that can perform the disclosed functions of the computing device 18.

Three exemplary operational scenarios of the portable timer system 10 will be described below. In a first exemplary operational scenario, the programming of a portable timer 12 and the use thereof in a food device 14 will be described. In a second exemplary operational scenario, transfer of food products from one food device 14 to another is described. In a third exemplary scenario, a method of tracking and managing food product inventory with the portable timer system 10 is described. In the disclosed examples shown in FIGS. 1 and 2, and described in the three exemplary operational scenarios below, the food devices 14 are chosen to be the food warming cabinets 14 to illustrate the operation of the disclosed portable timer system 10. Also, for illustrating the operation of the portable timer system 10, the two warming cabinets 14 shown in FIGS. 1 and 2 are labeled with reference numbers 14(a) and 14(b). However, as described in the foregoing, various food devices 14 can be used in the portable timer system 10, and the following operational methods are equally applicable to different food devices 14 that are not discussed in detail herein.

One of ordinary skill in the art will readily appreciate that each portable timer 12 may include only the internal clock 21 and a display device 20 so as to simply function as only a timer. Accordingly, the internal clock 21 can be started, stopped, and reset by a user depending on the operation being performed on a food item by a food device 14. Thus, a user can keep track of the timer the food item has been operated on by one or more food devices 14 in a restaurant. Each portable timer 12 may also include one or more portable timer components described in the foregoing in addition to the internal clock 21. Accordingly, each portable timer 12 can provide additional functions besides simply timing the food item being operated on by a food device. Such functions will become apparent with the following three exemplary operational scenarios.

In the first exemplary operational scenario, the programming of a portable timer 12 and the use thereof in a warming cabinet 14 will be described. An operator can program a portable timer 12 by inserting it in one of the timer slots 70 of the timer programming station 16. Alternately, a number of portable timers 12 that have not been programmed may be available and already in the timer slots 70 of the timer programming station 16. A user can program the portable timer 12 with the control panel 76 of the timer programming station 16. For example, a user can select the type of food products monitored by the portable timer 12. The control panel 76 can activate a menu that is displayed on the display device 74 from which the user can select the type of food products for the portable timer 12.

Once the user selects the type of food products, the programming station 16 downloads information into the memory 22 of the portable timer 12. Such information can include, but is not limited to, the cooking temperature of the food products, the storage temperature of the cooked food products, the amount of time the cooked food products can be kept at the storage temperature, and the quantity of the food products. Other information may include a numerical identifier for the portable timer 12 relative to other portable timers 12 that are used in the restaurant (e.g., timer no. 12 of 26), inventory information about that type of food products, and current availability of the food products for immediate service.

The portable timer 12 can also be programmed by the warming cabinet 14 to which it will be connected. Such a warming cabinet 14 includes the hardware and/or the software that can function similar to the programming station 16. For example, a user can insert a portable timer 12 in the communication slot 60 of the warming cabinet 14 and use the user interface 54 of the warming cabinet 14 to program the portable timer 12.

When an operator places a food tray 53 that is holding a food product for which the portable timer 12 is programmed in the slots 52 of the warming cabinet 14, and the portable timer 12 is inserted in the communication slot 60, the warming cabinet receives information about the food products in the food tray 53 from the portable timer 12. As described above, the exchange of information between the warming cabinet 14 and the portable timer 12 may be automatic or activated by the operator. The warming cabinet 14 can then use the information to adjust its operational parameters and conditions in accordance with the type of food products being placed in the food trays 53. For instance, the warming cabinet 14 can adjust the temperature of the slot 52 to match the specific warming temperature requirement of the food products. The information from the portable timer 12 and the adjustments made by the warming cabinet 14 can be provided to an operator on the display panel 56 of the warming cabinet 14 or on the display device 20 of the portable timer 12.

The display device 20 of the portable timer 12 or the display panel 56 of the warming cabinet 14 can show the time the food products has been held in the slot 52 or the time remaining before the food products can no longer be served. The display device 20 of the portable timer 12 may be programmed to change colors, flash, or emit other visual indicators that convey to an operator the food products in the food tray 53 is nearing expiration. Additionally, the portable timer 12 or the food device 14 to which it is connected can include an audio alarm device for sounding an alarm when an operator's attention is required, such as when the food product is nearing expiration or has expired. When the holding period of the food products expires, the operator can remove the food tray 53 from the slot 52, and also remove the portable timer 12 from the communication slot 60. The portable timer 12 can then be returned to an open timer slot 70 of the timer programming station 16. The return of the portable timer 12 may cause an exchange of information between the timer programming station 16 and the slot 70. Such information may include data regarding the last operation of the portable timer 12.

In the second exemplary operational scenario, the process of transferring food products from the warming cabinet 14(a) to the warming cabinet 14(b) will be described. Also, the operation of the portable timer system 10 during the transfer will be described. When a food tray 53 is in a slot 52 of the warming cabinet 14(a), an operator may wish to move the food tray 53, including the food products therein, to another warming cabinet 14(b). As described above in the first exemplary operational scenario, the portable timer 12 associated with the slot 52 includes updated information about the food products in the food tray 53 of the slot 52. Accordingly, because this information should also be transferred from the warming cabinet 14(a) to the warming cabinet 14(b), the portable timer 12 corresponding to the transferring food tray 53 is also transferred to the warming cabinet 14(b).

To transfer of the portable timer 12, the operator can simply pull the portable timer 12 out of the communication slot 60 of the warming cabinet 14(a). The information about the food products in the food tray 53 may be periodically stored on the corresponding portable timer 12. Accordingly, when the portable timer 12 is pulled out of the communication slot 60, the information in the memory 22 is from the last stored session. However, one of ordinary skill in the art will recognized the time interval at which the information is saved on the portable timer 12 can dictate up-to-date status of the information. For example, if the information is stored on the portable timer 12 at every second, the information may be considered as fairly up-to-date. In contrast, if the information is stored on the portable timer at every five minutes, the information may be considered not very up-to-date.

Alternately, the operator can optionally store up-to-date information on the portable timer 12 prior to pulling it out of the communication slot 60. Pressing one or more of the buttons 33 of the portable timer could provide such a function. For example, the operator can press one button 33 to initiate the transfer, causing the storing of information on the portable timer 12. When the information has been updated, the display device 20 of the portable timer 12 can indicate to the operator that the portable timer 12 can be pulled out. Accordingly, the operator can pull out the portable timer 12.

The portable timer 12 will continue to track the time during the transfer process with the software or hardware driven timer that is internal to the portable timer 12. When the portable timer 12 in inserted in the communication slot 60 of the transferee warming cabinet 14(b), the warming operation will resume on the transferred food tray 53. Insertion of the portable timer 12 in the communication slot 60 can also send information to the warming cabinet 14(b) about the warming temperature and warming time of the food products in the food tray 53. Accordingly, the warming cabinet 14(b) can adjust the temperature of the slot 52, in which the food tray 53 is inserted.

In a third exemplary scenario, a method of tracking and managing food product inventory with the portable timer system 10 is described. As described above, the portable timers 12 may include the internal memory 22 that can store information about the operation of the portable timer 12. The internal memory 22 can track the operation of the portable timer 12 by storing a history of the operation of the portable timer 12. Such historical information can then be uploaded from the portable timer 12 into the timer programming station 16, the computing device 18, and/or the handheld device 19 when the portable timer 12 is inserted in a timer slot 70. For example, a portable timer 12 that has been timing the holding of a particular food product in a food warming cabinet 14 can include historical information, such as, the type of food product being timed, the quantity of food products used, the quantity of food products that expired, the amount of time the food products were held in the warming cabinet 14, the rate by which the food products were used, and actions taken by an operator while the food products were held in the warming cabinet 14 (e.g., adjusting the temperature of the slot 52).

The historical information uploaded from each portable timer 12 after each operational session of the portable timer 12 can be used to manage the food product inventory in a restaurant. For example, the information upload from each portable timer 12 can be used by the computing device 18 and/or the handheld device 19 to determine daily quantity requirements for each food product being served at the restaurant. Accordingly, the computing device 18 and/or the handheld device 19 can issue an alert to an operator that more food products are needed in the near future. The operator can then take such actions as ordering more food products and taking frozen food products out of storage for processing and cooking. An example of methods of inventory management and restaurant operation is disclosed in U.S. Reissue patent application Ser. No. 10/077,364, filed Feb. 14, 2002, the contents of which are incorporated by reference herein.

By having access to the historical information on each portable timer 12, the computing device 18 can keep track of the number and types of food products being stored, processed, prepared, and held at a temperature for service to customers. Accordingly, the computing device 18 can issue alerts to the operator to cook more food products, and prioritize the use of the food products based on the relative time each food product has been held. By accumulating daily information about the food products, the computing device 18 can predict the amount of cooked food products that are necessary at any time during the day. For instance, a certain type of food product that is served during lunch may be so popular based on the historical sales data for that food product that the computing device 18 may issue an alert to the operator to prepare the food products for service well in advance of the period when lunch is served. By tracking food inventories, predicting food usage, and managing the operation of the portable timers 12, the disclosed portable timer system 10 can accurately predict inventory levels, such that fresh food products are always available for service and the wasting and discarding of expired or spoiled food products are avoided as much as possible.

One of ordinary skill in the art will readily appreciate that the more information the portable timer 12 is capable of saving in the internal memory 22 during operation, the more accurately the inventory of food products and usage of the food products can be predicted. However, such accuracy may have to be balanced with system complexity and cost. Accordingly, the portable timer system 10 can be designed with hardware and software requirements that provide a desired level of operation and inventory management capability. For example, in a simple portable timing system 10, only the quantities of the food products being used may be tracked. Accordingly, the inventory management of the portable timer system 10 may be only capable of issuing alerts to a user when the inventory levels of the food products fall below predetermined levels. In a more complex system, for example, every handling, manipulation, and processing of a food product, from delivery to the restaurant until a point of sale can be tracked in real time to provide an accurate and versatile operational and inventory management system.

FIGS. 1 and 2 generally illustrate two exemplary portable timer systems 10. In FIG. 1, the food devices 14 and the timer programming device 16 do not communicate. Accordingly, each of the food devices 14 and the timer programming device 16 may include a computing device 18. The portable timer system 10 of FIG. 1 uses the internal memory 22 of each portable timer 12 to facilitate the exchange of information between the food device 14, the portable timers 12, and the timer programming device 16. For example, as described above, when a user initiates a transfer of a food tray 53 from the warming cabinet 14(a) to the warming cabinet 14(b), the corresponding portable timer 12 stores all the necessary information for the transfer in the internal memory 22 thereof. When the food tray 53 is placed in the warming cabinet 14(b), the portable timer 12 transfers the information about the food tray 53 and the food products therein to the warming cabinet 14(b). Based on the read information, the warming cabinet 14(b) can then operate on the food tray 53 from where the warming cabinet 14(a) left off.

Because the food devices 14, the timer programming device 16, and the computing device 18 of the portable timer system 10 of FIG. 1 do not communicate with each other, the portable timers 12 facilitate the information exchange between such devices for operation and inventory management. The portable timer system 10 of FIG. 1 may include one or more of the handheld devices 19. An operator insert any of the portable timers 12 of the portable timer system 10 of FIG. 1 in the communication port of the handheld device 19. Accordingly, the handheld device 19 can exchange information with any of the portable timers 12.

Referring to FIG. 2, the food devices 14 and the timer programming device 16 communicate with each other through the computing device 18. Such communication can be facilitated by wired or wireless networking methods and hardware that are well known to those of ordinary skill in the art. In FIG. 2, the computing device 18 not only functions as a communications hub, but may also function as a centralized computing device 18. Accordingly, the computing device 18 can receive information from or exchange information with the food devices 14 and the timer programming device 16. The computing device 18 can accumulate and process the communicated information to provide control of the food devices 14 and the programming device 16, and to provide inventory management functions. For example, information indicating the number of food products and the rate by which the food products are sold to customers in a restaurant can be processed by the computing device 18 to issue a command to the operator to replenish the food product's inventory. Additionally any updates in the inventory management software and method may be performed by simply updating the operational software of the computing device 18.

Alternately, to provide a near real-time or accurately predictive inventory management system, each portable timer 12 can include wireless communication capabilities to continuously or periodically exchange information with the computing device 18. Such wireless communication capabilities are well known to those of ordinary skill in the art and can be based on the IEEE 802.11x standards. The computing device 18 can process the information and accordingly control the operation of the food devices 14, the timer programming device 16, and the portable timers 12.

The portable timer system 10 of FIG. 2 can also include the one or more handheld device 19 that can function as independent computing devices or as extensions of the computing device 18. Each of the handheld devices 19 can be capable of wireless communication so as to exchange information with the food devices 14, the timer programming device 16, the portable timers 12, and the computing device 18. Information regarding various operational aspects of the portable timer system 10, including inventory information, can be conveyed to an operator of the handheld device 19. The operator of the handheld device 19 can also control some of all operational aspects of the portable timer system 10 by the handheld device 19. In effect, the handheld device 19 can provide some or all the functions of the computing device 18 in a mobile platform.

Other well known networking or information exchange configurations for the portable timer system 10 can be used. Such configurations may include variations of the two above-described exemplary portable timer systems 10 or hybrid variations thereof. For example, the food devices 14, the programming device 16, the computing device 18, and the handheld device 19 can be connected in a peer-to-peer manner. Accordingly, one or more of the food devices 14 and the programming device 16 can include one or more computing devices 18, the resources of which may be shared by the entire portable timer system 10. In yet another example, the food device 14 may be connected by a wireless network, while the timer programming station 16, the computing device, 18 and the handheld devices 19 may be connected by a wireless network.

Persons of ordinary skill in the art will appreciate that, although the teachings of the invention have been illustrated in connection with certain embodiments, there is no intent to limit the invention to such embodiments. On the contrary, the intention of this application is to cover all modifications and embodiments fairly falling within the scope of the teachings of the invention.

1. A portable timer system comprising:
a plurality of portable timers, each portable timer adapted to include information about a food product, and each portable timer being operatively connectable to a food device operating on the food product and operatively disconnectable from the food device operating on the food product; and
a timer programmer adapted to program each portable timer.

2. The portable timer system of claim 1, wherein each portable timer includes a timing device.

3. The portable timer system of claim 1, wherein each portable timer includes a data storage device.

4. The portable timer system of claim 1, wherein each portable timer includes a timer computing device.

5. The portable timer system of claim 4, wherein each portable timer includes an operational software executed by the timer computing device.

6. The portable timer system of claim 1, wherein each portable timer includes a user interface.

7. A portable timer system for restaurant inventory management, the portable timer system comprising:
a plurality of portable timers, each portable timer operatively connectable to food devices in the restaurant and operatively disconnectable from the food devices in the restaurant, each portable timer adapted to include information about at least one food product of a plurality of food products operated on by the food devices; and
a computing device adapted to receive from the portable timers information about the plurality of food products and manage the information.

8. The portable timer system of claim 7, wherein the computing device is a mobile computing device.

9. The portable timer system of claim 7, further comprising a mobile computing device operatively coupled to the computing device.

10. The portable timer system of claim 7, further comprising a programming device adapted to receive and program each of the portable timers.

11. The portable timer system of claim 7, wherein the food devices and the computing device communicate by a communication network.

12. The portable timer system of claim 11, wherein the communication network is a wireless network.

13. The portable timer system of claim 7, wherein each portable timer communicates with the computing device by a communication network.

14. The portable timer system of claim 13, wherein the communication network is a wireless network.

15. The portable timer system of claim 7, wherein each portable timer includes a timing device.

16. The portable timer system of claim 7, wherein each portable timer includes a data storage device.

17. The portable timer system of claim 7, wherein each portable timer includes a timer computing device.

18. The portable timer system of claim 17, wherein each portable timer includes an operational software executed by the timer computing device.

19. The portable timer system of claim 7, wherein each portable timer includes a user interface.

20. A method of restaurant inventory management comprising:
storing information about a food product on a portable timer;
connecting the portable timer to a first food device, the first food device adapted to operate on the food product; and
tracking information about the food product responsive to the first food device operating on the food product.

21. The method of claim 20, further comprising updating the information on the portable timer about the food product responsive to the first food device operating on the food product.

22. The method of claim 20, further comprising transferring the food product from the first food device to a second food device, the transferring comprising:
updating the information on the portable timer based on the operation of the first food device on the food product including the time the food product has been operated on by the first food device;
transferring the food product from the first food device to the second food device, the food device adapted to operate on the food product;
disconnecting the portable timer from the first food device, the disconnecting causing the portable timer to maintain the information about the food produce including the time the food product is operated on by the first food device;
connecting the portable timer to the second food device, the connecting causing the second food device to continue operation on the food product from the operation in the first food device; and
tracking the operation of the second food device on the food product, the tracking including the time the food product was operated on by the first food device and the time the food product is operated on by the second food device.

23. The method of claim 22, wherein the connecting causes the second food device to receive information from the portable timer about operation of the second food device on the food product.

24. The method of claim 20, wherein the storing of information on the portable timers is provided by a programming device capable of writing information on the portable timers.

25. The method of claim 20, wherein the information stored on the portable timers includes the type of the food product being operated on by the first food device.

26. The method of claim 20, wherein the tracking comprises the portable food timer and the first food device communicating the information about the food product.

27. The method of claim 26, wherein the tracking comprises updating the information on the portable timer, the updating causing the portable food timer and the first food device to communicate updated information about the food product.

28. The method of claim 20, further comprising processing the information during at least one of the storing and the tracking, the processing being performed by at least a computing device.

29. The method of claim 28, wherein at least one of the storing and the tracking is performed with the computing device by the portable timers being operationally coupled to the computing device and communicating information with the computing device by a communication network.

30. The method of claim 28, wherein at least one of the storing and the tracking is performed with the computing device by the food devices being operationally coupled to the computing device and communicating information with the computing device by a communication network.

31. The method of claim 27, wherein the processing of the information by the computing device provides restaurant operational and inventory information.

32. The method of claim 20, further comprising accumulating the information about the food products and providing restaurant operational and inventory management responsive to the accumulated information about the food products.
